(19) United States
(12) Patent Application Publication
(10) Pub. No.: US 2005/0255348 A1
(43) Pub. Date: Nov. 17, 2005

(54) Fuel for solid electrolyte type fuel cell and solid electrolyte type fuel cell and a method of using it

(76) Inventors: Takashi Manako, Tokyo (JP); Tsutomu Yoshitake, Tokyo (JP); Yuichi Shimakawa, Tokyo (JP); Shin Nakamura, Tokyo (JP); Sadanori Kuroshima, Tokyo (JP); Hidekazu Kimura, Tokyo (JP); Hideto Imai, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/519,550

(22) PCT Filed: Jun. 27, 2003
(86) PCT No.: PCT/JP03/08240

§ 371 Date: Dec. 28, 2004

(30) Foreign Application Priority Data
Jun. 28, 2002 (JP) 2002-190985

(51) Int. Cl. H01M 8/04; H01M 8/10; C10L 1/12

(52) U.S. Cl. 429/15; 429/30; 429/46; 44/458

(57) ABSTRACT

The present invention provides a solid electrolyte type fuel cell that can control a cross-over, and implements the high fuel efficiency and the high output of the fuel cell.

A substance is dissolved to a fuel 124, and does not permeate a solid polymeric electrolyte film 114. Because of this, on an interface between the solid polymeric electrolyte film 114 and the fuel 124 in a fuel electrode 102, an osmotic pressure in a direction from an oxide agent electrode 108 to a fuel electrode 102 is generated. Because of this, the water movement from the fuel electrode 102 side to the oxidizing agent electrode 108 side is controlled, and the cross-over of the fuel is controllable.

### TECHNICAL FIELD

The present invention relates to a fuel for solid electrolyte type fuel cell and a solid electrolyte type fuel cell and a method of using it. Particularly, it relates to the fuel for solid electrolyte type fuel cell and the solid electrolyte type fuel cell and the method of using it, which are capable of controlling a cross-over of the solid electrolyte type fuel cell, and capable of implementing a high fuel efficiency and a high output of the fuel cell.

### BACKGROUND OF THE ART

The solid electrolyte type fuel cell is an apparatus for generating electricity from the electrochemical reaction by supplying an oxygen to an oxidizing agent electrode, and by supplying a hydrogen to a fuel electrode, comprising a solid polymeric electrolyte film such as perfluorosulfonate film as the electrolyte, and the fuel electrode and the oxidizing agent electrode are joined to both faces of this film.

The following electrochemical reaction is taking place in each electrode.
H₂→2H⁺+2e⁻ Fuel electrode:
½O₂+2H⁺+2e⁻→H₂O Oxidizing agent electrode:

From this reaction, the solid electrolyte type fuel cell can achieve a high output of more than 1 A/cm2 at the normal temperature and pressure.

The fuel electrode and the oxidizing agent electrode are comprised of the mixture of solid polymeric electrolyte and carbon powders supporting catalyst material. In general, this mixture is coated on top of an electrode substrate such as carbon paper, becoming a gas diffusion layer of the fuel. The solid polymeric electrolyte film is sandwiched by the two electrodes, and it is heat compressed; and the fuel cell is configured accordingly.

In the fuel cell under this configuration, a hydrogen gas supplied to the fuel electrode reaches the catalyst by passing through the pores of the electrode, the electrons are released, and the hydrogen ion is formed. The released electrons are guided to an outer circuit through a solid electrolyte and carbon powders in the fuel electrode, and flown into the oxidizing agent electrode from the outer circuit.

On the other hand, the hydrogen ion generated at the fuel electrode reaches the oxidizing agent electrode through the solid polymeric electrolyte in the fuel electrode and the solid polymeric electrolyte film positioned in between the two electrodes. As indicated in the above reaction equations water is generated by reacting with the electrons flown in from the outer circuit and the oxygen supplied to the oxidizing agent electrode. As a result of this, in the outer circuit, the electron flows from the fuel electrode towards the oxidizing agent electrode, and the electric power is taken out.

As above, the fuel cell with hydrogen as its fuel has been described, however, in recent years, a fuel cell using a liquid organic fuel such as methanol is extensively being researched and developed.

Well-known fuel cells using the liquid organic fuel are those that purifies the liquid organic fuel to a hydrogen gas to be used as a fuel, and those represented by a direct methanol type fuel cell which directly supplies the liquid organic fuel to the fuel electrode without purifying.

Among them, the fuel cell that directly supplies the liquid organic fuel to the fuel electrode without purifying, it has the configuration that can supply the liquid organic fuel directly to the fuel electrode, and it does not require an apparatus such as purifier. Therefore, it has the merit in the cell configuration being simple, and the whole apparatus can be made small. Moreover, in comparison to the gas fuels such as hydrogen gas and hydrocarbon gas, the liquid organic fuel has an advantage of facilitating a safe transport.

In general, the fuel cell using the liquid organic fuel utilizes the solid polymeric electrolyte film made of a solid polymeric ion exchange resin as the electrolyte. Herewith, for the fuel cell to function, the hydrogen ion must move from the fuel electrode to the oxidizing agent electrode through this film. Since the movement of hydrogen ion accompanies the movement of water, therefore, a certain amount of moisture must be contained in the film.

However, in the case of using the liquid organic fuel such as methanol especially having a high hydrophilic property to water, the liquid organic fuel is diffused in the solid polymeric electrolyte film containing water, and furthermore, it reaches to the oxidizing agent electrode to cause a phenomenon called cross-over. If the cross-over is generated, the liquid organic fuel for supplying electrons in the fuel electrode is oxidized at the oxidizing agent electrode, and it is not effectively utilized as the fuel. Because of this, the voltage and output are decreased which causes a decline in the fuel efficiency.

### DISCLOSURE OF THE INVENTION

Accordingly, the present invention aims to provide a fuel for solid electrolyte type fuel cell capable of controlling the cross-over.

Furthermore, the present invention aims to provide a fuel for solid electrolyte type fuel cell capable of the high fuel efficiency and the high output of the solid electrolyte type fuel cell.

Furthermore, the present invention aims to provide a method of using the solid electrolyte type fuel cell capable of controlling the cross-over.

Furthermore, the present invention aims to provide the method of using the solid electrolyte type fuel cell having the high fuel efficiency and the high output.

Furthermore, the present invention aims to provide a solid electrolyte type fuel cell capable of controlling the cross-over. Furthermore, the present invention aims to provide a solid electrolyte type fuel cell having the high fuel efficiency and the high output.

According to one aspect of the present invention solving these topics, a fuel for a fuel cell having a solid electrolyte film, wherein the fuel comprises a liquid organic fuel, and a compound excluding sulfuric acid dissolved in the liquid organic fuel that does not permeate the solid electrolyte film.

As a solid electrolyte film to be used in the solid electrolyte type fuel cell, in general, a solid electrolyte film having a high hydrogen ion conductivity, represented by Nafion®, is utilized. The high hydrogen ion conductivity of the solid electrolyte film such as this, is generated by inclusion of water in the solid electrolyte, on the other hand, due to this moisture content, the liquid organic fuel such as methanol facilitates dissolution to water, and urges the occurrence of cross-over by reaching to the oxidizing agent electrode.

Henceforth, the present invention focuses on an osmotic pressure generated at an interface between a solid electrolyte film and a liquid organic fuel supplied to a fuel electrode, and a substance that does not permeate the solid electrolyte film is dissolved in the fuel as a compound. The solid electrolyte film permeates water, on the other hand, it functions as a partial film that does not permeate the compound. Because of this, at the interface between the solid electrolyte film and the liquid organic fuel, an osmotic pressure in a direction from the oxidizing agent electrode to the fuel electrode is generated. Therefore, the water movement from the fuel electrode side to the oxidizing agent side is controlled, such that the movement of liquid organic fuel to the oxidizing agent side is also reduced. That is, the cross-over can be decreased.

Herewith, conventionally, a fuel cell technology for generating electricity by supplying a substance other than the fuel to the fuel electrode accompanied by the fuel did exist. For example, Japanese examined patent publication No. HEI 8-21396 discloses a fuel cell technology for generating electricity by supplying a fuel containing methanol and sulfuric acid. The sulfuric acid is supplied as the electrolyte solution for transporting the hydrogen ion. Henceforth, in order to maintain the hydrogen ion conductivity, a concentration of the sulfuric acid is set more than a certain value, and the fuel must be kept strongly acidic. Because of this, the corrosion of metallic components in the cell such as collector and metallic seal is readily progressed, and the long-term reliability of the cell is not sufficient, and the cell may be damaged. Moreover, when the cell is damaged and the sulfuric acid came in contact to the human body, since the sulfuric acid is non-volatile, it causes skin structure damages and inflammations, and a bad influence is of a great concern. The present invention attempts to solve the problem by utilizing a compound other than the sulfuric acid as the compound to be dissolved in the liquid organic fuel. Moreover, according to another aspect of the present invention, in the fuel for solid electrolyte type fuel cell, the compound is preferably non-electrolyte.

In the case of operating the fuel cell by serially connecting a plurality of unit cells for obtaining a high electro-motive power, when electrolyte is added to the fuel, water electrolysis is generated, and the obtained output is declined. Under such circumstance, by selecting the non-electrolyte as the compound, the water electrolysis is controlled, and an osmotic pressure is generated.

Moreover, according to another aspect of the present invention, in the fuel for solid electrolyte type fuel cell, the compound is preferably an organic compound except for the liquid organic fuel.

Since an organic compound except for the liquid organic fuel is added to the fuel for solid electrolyte type fuel cell, an electric resistance of the fuel is maintained high. Because of this, inside the fuel cell, the water electrolysis is controlled, and the osmotic pressure is generated. The organic compound is preferably at least one type selected from sugar groups, alcohol groups and amine groups. The compound is either one of the sugar groups, alcohol groups and amine groups, therefore, it is neutral to weakly basic. Henceforth, the compound does not corrode the metallic components inside the fuel cell, and the long-lasting reliability of the fuel cell is secured. Moreover, the sugar groups, alcohol groups, and amine groups are electrochemically stable, therefore, a stable osmotic pressure is effectively generated.

Moreover, according to another aspect of the present invention, the compound is preferably a strong electrolyte excluding the sulfuric acid.

The strong electrolyte is dissolved in a liquid organic fuel in the dissipated condition into positive ion and negative ion. The negative ion cannot permeate through a solid electrolyte film. This is because the solid electrolyte film comprises a lot of negatively charged functional groups such as sulfonic acid group for supporting the hydrogen ion conductivity. The negative ion electrically repels from these functional groups. Henceforth, an osmotic pressure is generated at an interface between a fuel and a solid electrolyte film.

Moreover, if a strong electrolyte is selected, it becomes possible to obtain a high osmotic pressure at a small amount of addition of the strong electrolyte. For example, in the case of dissolving a single molecule of Na2SO4 in the fuel, the Na2SO4 molecule is electrolyzed into two Na+ ions and one SO42− ion. Because of this, an osmotic pressure of three molecules is provided from a single Na2SO4 molecule.

Moreover, by dissolving an electrolyte to a fuel, the conductivity of the fuel is improved. The inner resistance loss of the fuel cell is reduced from this, which can contribute to the improved output of the fuel cell.

The sulfuric acid is a strong electrolyte, however, being strongly acidic and non-volatile, as described previously, form the notions of influence on human and securing long-lasting reliability of the cell, it is exempted as the strong electrolyte in the present invention.

Moreover, according to another aspect of the present invention, in the fuel for solid electrolyte type fuel cell, the strong electrolyte is preferably chloride, nitrate, and sulfate.

By selecting the above compound as the strong electrolyte, the fuel can be maintained neutral, and the corrosion of the metallic components inside the fuel cell is not generated so that the durability of fuel cell is unaffected, capable of resolving the problem of cross-over.

Moreover, according to another aspect of the present invention, in the fuel for solid electrolyte type fuel cell, the compound concentration is preferably ranging from 1 mmol/L to 1 mol/L.

By setting the compound concentration ranging from 1 mmol/L to 1 mol/L, a sufficient osmotic pressure necessary to reduce the cross-over is generated.

Moreover, according to another aspect of the present invention, the fuel for solid electrolyte type fuel cell preferably has a pH value ranging from 4 to 8.

By setting the pH value of the fuel for solid electrolyte type fuel cell in the range of 4 to 8, a bad influence to the solid electrolyte film and corrosion of metallic components inside the fuel cell are prevented, and can contribute to the stable fuel cell operation.

Moreover, according to another aspect of the present invention, a method of using the solid electrolyte type fuel cell comprising a fuel electrode, an oxidizing agent electrode, and a solid electrolyte film positioned in between the fuel electrode and the oxidizing agent electrode, wherein a fuel includes a liquid organic fuel and a compound excluding the sulfuric acid dissolved in the liquid organic fuel without permeating the solid electrolyte film, wherein the fuel is supplied to the fuel electrode.

The problem of cross-over is resolved by this method, and a favorable and stable long-lasting cell efficiency is implemented.

Moreover, according to another aspect of the present invention, the solid electrolyte type fuel cell comprises a fuel electrode, an oxidizing agent electrode, a solid electrolyte film positioned in between the fuel electrode and the oxidizing agent electrode, and a fuel supplied to the fuel electrode, wherein the fuel includes a liquid organic fuel and a compound excluding the sulfuric acid dissolved in the liquid organic fuel without permeating the solid electrolyte film.

In the solid electrolyte type fuel cell of the present invention, the cross-over of the liquid organic fuel is controlled, therefore, the output is high and the cell efficiency is favorable.

Moreover, according to another aspect of the present invention, it further includes a supplying step for supplying the fuel for solid electrolyte type fuel cell to the fuel electrode.

The fuel cell related to the present invention has a fuel electrode, an oxidizing agent electrode, and a solid electrolyte film sandwiched between the fuel electrode and the oxidizing agent electrode, and adopts configuration which directly supplies a liquid organic fuel to the fuel electrode, which is so-called direct type fuel cell. The direct type fuel cell has the high cell efficiency, and has advantages such as capable of attempting reduction in space because the purifier is not necessary. Yet, the problem of cross-over of the liquid organic fuel such as methanol remains. According to the present invention, the problem of cross-over is solved, and favorable and stable long-lasting fuel efficiency is implemented.

Moreover, according to another aspect of the present invention, the solid electrolyte type fuel cell further includes preferably a recycling step for recycling the used fuel expelled from the fuel electrode, a concentration adjusting step for adjusting concentrations of the compound and the liquid fuel in the used fuel recycled at the recycling step, and a transporting step for transporting the used fuel having adjusted the concentration at the concentration adjusting step to the supplying step.

The fuel cell of the present invention can reuse the liquid organic fuel unconsumed at the fuel electrode, so that the liquid organic fuel is used non-wasted at high efficiency.

### BRIEF DESCRIPTION OF THE DRAWINGS

FIG. 1 is a schematic cross-sectional view showing one example of the configuration of the solid electrolyte type fuel cell according to one embodiment of the present invention.

FIG. 2 is a schematic cross-sectional view showing one example of the configuration of the fuel cell according to one embodiment of the present invention.

FIG. 3 is a schematic block diagram showing one example of the configuration of the fuel supplying system of the fuel cell according to one embodiment of the present invention.

### BEST MODES FOR CARRYING OUT THE INVENTION

Hereunder, one embodiment of the present invention shall be described with reference to the drawings.

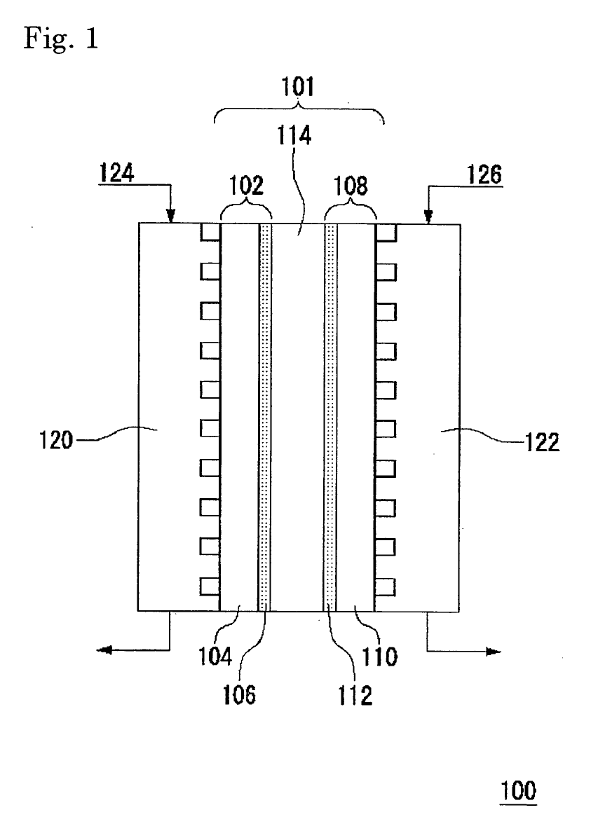

FIG. 1 is a schematic cross-sectional view showing one example of the configuration of the solid electrolyte type fuel cell according to one embodiment of the present invention. A fuel cell 100 comprises a plurality of electrode and electrolyte assemblies 101. The plurality of electrode and electrolyte assemblies is electrically connected to one another via a fuel electrode side separator 120 and an oxidizing agent electrode side separator 122. Each of the plurality of electrode and electrolyte assemblies is comprised of a fuel electrode 102, an oxidizing agent electrode 108, and a solid polymeric electrolyte film 114. The fuel electrode 102 is further comprised of a substrate 104 and a catalytic layer 106. The oxidizing agent electrode is further comprised of a substrate 110 and a catalytic layer 112.

At a fuel electrode 102 of each electrode and electrolyte assembly 101, a fuel 124 is supplied via the fuel electrode side separator 120. Moreover, at an oxidizing agent electrode 108 of each electrode and electrolyte assembly 101, an oxidizing agent 126 such as air or oxygen is supplied via the oxidizing agent electrode side separator 122.

The solid polymeric electrolyte film 114 separates the fuel electrode 102 and the oxidizing agent electrode 108, and it also has a role of moving the hydrogen ion between the two. Because of this, the solid polymeric electrolyte film 114 is preferably a film with the high hydrogen ion conductivity. Moreover, it is preferably a chemically stable film with a high mechanical strength.

A material comprising the solid polymeric electrolyte film 114 includes the organic polymers having polar groups such as strongly acidic groups such as sulfone group, phosphate group, phosphone group, and phosphine group; and a weakly acidic groups such as carboxyl group. The typical and preferred examples of the organic polymers having polar groups such as these include: an aromatic group containing high molecules such as sulfonation of poly (4-phenoxybenzoyl-1,4-phenylene), and alkyl sulfonation polybenzimidazole; polystyrene sulfonate copolymer, polyvinylsulfonate copolymer, and copolymer such as fluoride containing high molecules consisting of bridging alkyl sulfonate derivative, fluoride resin structure, and sulfonate; copolymer obtained by copolymerization of acrylate group such as n-butyl methacrylate and acrylamide group such as acrylamide-2-methyl-propane-sulfonate; sulfone group containing perfluorocarbon such as Nafion® (Du Pont) and Aciplex® (Asahi Kasei); and carboxyl group containing perfluorocarbon such as Flemion® S-film (Asahi Glass). It should be noted that the examples are not necessarily limited to these. Among these, if aromatic group containing high molecules such as sulfonation of poly (4-phenoxybenzoyl-1,4-phenylene) and alkyl sulfonation polybenzimidazole are selected, the permeation of liquid organic fuel is controlled, and decline in the cell efficiency due to cross-over is suppressed.

As for both substrates 104 and 110 of the fuel electrode 102 and the oxidizing agent electrode 108, respectively, the porous substrate such as carbon paper, carbon shape, sintered carbon, sintered metal, and foamed metal can be utilized. Moreover, as for the water-repelling process of the substrate, water repellent agent such as polytetrafluoroethylene is utilized.

The typical examples of catalysts of the fuel electrode 102 are platinum, rhodium, palladium, iridium, osmium, ruthenium, rhenium, gold, silver, nickel, cobalt, lithium, lanthanum, strontium, and yttrium. However, examples are not necessarily limited to these. The catalysts indicated above can be used alone or in combination or more than two types.

On the other hand, as a catalyst of the oxidizing agent electrode 108, the same catalyst as the fuel electrode 102 can be utilized, and the above examples can be used. Note that the same catalyst can be used as the catalysts of the fuel electrode and the oxidizing agent electrode, alternatively, different catalysts can be used.

Moreover, examples of carbon powders for supporting the catalysts are acetylene black (such as Denka Black® (Denki Kagaku Kogyo) XC72 (Vulcan) ), ketjen black, carbon nano tube, and carbon nanohorn. Particle diameter of carbon powders, for example, is 0.01 to 0.1 μm, and more preferably 0.02 to 0.06 μm.

Moreover, a liquid organic fuel having a C—H bond is preferably used as a fuel. Typical examples of liquid organic fuel having the C—H bond includes: alcohol groups such as methanol, ethanol, and propanol; ether groups such as dimethylether; cyclo parafin groups such as cyclo hexane; cyclo parafin groups having hydrophilic group such as hydroxyl group, carboxyl group, amino group, and amide group; and monosubstituted or disubstituted cyclo parafin. However, the examples are not necessarily limited to these. Herewith, the cyclo parafin groups refer to cyclo parafins and their substitute besides the aromatic compounds.

In the fuel for the fuel cell of the present invention, for the purpose of generating an osmotic pressure, a compound not permeating the solid polymeric electrolyte film 114 is dissolved. By doing so, at an interface between the solid polymeric electrolyte film 114 and the fuel 124 in the fuel electrode 102, an osmotic pressure is stably generated in a direction from the oxidizing agent electrode 108 to the fuel electrode 102, and water movement from the fuel electrode 102 to the oxidizing agent electrode 108 is controlled. Due to the water movement controlled, the liquid organic fuel movement from the fuel electrode side to the oxidizing agent electrode side is decreased. Accordingly, the problem of cross-over is improved, and the cell efficiency is also improved.

Moreover, in order to generate the osmotic pressure stably, these compounds are preferably electrochemically inert, and furthermore, preferably volatile.

These compounds can be dissolved into the liquid organic fuel beforehand. Moreover, these compounds can be added to the liquid organic fuels immediately before operating the fuel cell.

Examples of the compounds satisfying these conditions above are the strong electrolytes and the organic compounds.

Typical examples of strong electrolytes include NaCl, KCl, NaNO3, NH4NO3, Na2SO4, K2SO4, (NH4)2SO4, NaHCO3, KHCO3, however, the examples are not necessarily limited to these.

The strong electrolyte is dissolved to a liquid organic fuel by separating to the positive ion and negative ion. Because of this, in the liquid organic fuel, single-molecule strong electrolyte acts as double-molecules or triple-molecules, hence a high osmotic pressure can be generated by small amount of addition.

The strong electrolyte has an effect of improving the hydrogen ion conductivity of the liquid organic fuel, therefore, an inner resistance of the cell is suppressed. Accordingly, the cell output is increased.

Herewith, the sulfuric acid (H2SO4) is a strong electrolyte, however, it is avoided from being selected as the compound. The sulfuric acid is strongly corrosive, and prominently deteriorates the metallic components inside the fuel cell, causing difficulty in supporting the long-term reliability of the fuel cell. Moreover, the sulfuric acid is non-volatile, and it may cause a bad influence on human skin structure such as damages and inflammations. Considering the safety factors upon fuel leakage and to be cautious upon handling the fuel, the sulfuric acid is not an ideal selection.

Examples of organic compounds are sugar groups, alcohol groups, and amine groups having hydrophilic properties.

Typical examples of sugar groups are sugars such as glyceraldehyde, dihydroxy-acetone, ribose, deoxyribose, xylose, arabinose, glucose, fructose, and galactose; sugar alcohol groups such as sorbitol, mannitol, and inositol; and amino sugar groups such as glucosamine and chondroitin. However, examples are not necessarily limited to these. Moreover, a plurality of the sugar groups listed above may be combined to form disaccharides, trisaccharides, and polysaccharides which are also usable.

Typical examples of alcohol groups are alcohol groups of more than 3 carbon atoms, for instance, a high-grade alcohol group such as heptanol, heptanediol, heptanetriol, octanol, octanediol, nonanol, nonanediol, and isononanol; cyclo aliphatic alcohol groups such as cyclo heptanol and cyclo nonanediol; polycyclic aliphatic alcohol of more than dicyclic; and compounds containing ethyl bond such as diethylene glycol. However, the examples are not necessarily limited to these.

Typical examples of amine groups are amine groups having more than 3 carbon atoms, for instances: aliphatic amine groups such as propanamine, diethylamine, triethylamine, tributylamine, butanamine; cyclic amine groups such as pyrrolidine, piperidin, piperazine, and morpholine. However, the examples are not necessarily limited to these.

Concentration of the compound above in the liquid organic fuel is ranging from 0.1 mmol/L to 5 mol/L, and more preferably is ranging from 1 mmol/L to 1 mol/L. This way, a sufficient osmotic pressure necessary to decrease the cross-over is possible.

Now, the fuel for the fuel cell dissolving the above compound preferably has the pH value ranging from 4 to 8. To provide the hydrogen ion conductivity, the solid electrolyte film keeps an acidic state. If the fuel is strongly alkaline, a neutralization reaction occurs inside the solid electrolyte film, and the hydrogen ion conductivity is lost. Accordingly, to avoid losing of the hydrogen ion conductivity, the pH value of the fuel for fuel cell is set in the range of 4 to 8. This way, it becomes possible to generate the osmotic pressure without inhibiting the operation of the fuel cell. Furthermore, if the pH of the fuel is in the range of 4 to 8, a highly reliable fuel cell is provided, without giving a bad influence such as corrosion of the metallic components such as current collector, electrode, or metallic seal.

From the following notions, either one of strong electrolyte compound or organic compound is preferably selected. The strong electrolyte is preferable from the notion of increasing the hydrogen ion conductivity. If the unit cells are connected in series, and the voltage of whole cells is more than 1 V, the water electrolysis is generated. Under such circumstance, the electrolyte is not adopted, and instead, the organic compounds mentioned above can be utilized. This way, the liquid resistance of fuel is appropriately maintained high, and the osmotic pressure is generated without generating the water electrolysis.

The production method of the fuel electrode 102 and the oxidizing agent electrode 108 of the present invention is not particularly limited. Followings are some of the production examples.

First of all, the catalyst support of the carbon powders for the fuel electrode 102 and the oxidizing agent electrode 108 is performed by generally adopted impregnation method. Then, the carbon powders supporting the catalyst and the solid polymeric electrolyte powders are dispersed in a solvent, and after forming a paste, it is coated to the substrate, drying it, and the fuel electrode 102 and the oxidizing agent electrode 108 are obtained accordingly. Herewith, a particle diameter of carbon powders, for example, is ranging from 0.01 to 0.1 μm. A particle diameter of catalyst powders, for example, is ranging from 1 nm to 10 nm. A particle diameter of solid polymeric electrolyte powders, for example, is ranging from 0.05 to 1 μm. Weight ratio of the carbon powders and the solid polymeric electrolyte powders, for example, is ranging from 2:1 to 40:1. Moreover, weight ratio of water inside the paste and solvent, for example, is ranging from 1:2 to 10:1. Coating method of the paste to the substrate is not particularly limited, for example, brushing, spraying, and screen printing methods can be utilized. The paste is coated at the thickness of approximately 1 μm to 2 mm. After the paste is coated, the coated substrate is heated at temperature and heating time depending on the fluoride resin in use, and the fuel electrode 102 and the oxidizing agent electrode 108 are produced accordingly. The heating time and temperature are appropriately selected depending on the material in use, for example, the temperature of 100° C. to 250° C., and the heating time of 30 seconds to 30 minutes.

The solid polymeric electrolyte film 114 of the present invention is produced by adopting an appropriate method depending on the material in use. For example, if the solid polymeric electrolyte film 114 is comprised of an organic polymer material, a liquid having dissolved or dispersed an organic polymer material to a solvent is obtained by casting on the detachable sheet such as polytetrafluoroethylene, and drying it.

The solid polymeric electrolyte film 114 produced accordingly is sandwiched by the fuel electrode 102 and the oxidizing agent electrode 108, it is hot-pressed, and the electrode and electrolyte assembly 101 is obtained. At this time, on the faces where the catalyst is prepared for both electrodes and the solid polymeric electrolyte film 114 should come in contact to one another. The hot pressing condition is selected depending on the material. If the solid polymeric electrolyte film 114 and the electrolyte film of the electrode surface is constituted with the organic polymer, the temperature exceeding the softening temperature and the glass transition temperature of these polymers can be used. Specifically, for example, the temperature of 100 to 250° C., the pressure of 5 to 100 kgf/cm2, and the time of 10 seconds to 300 seconds.

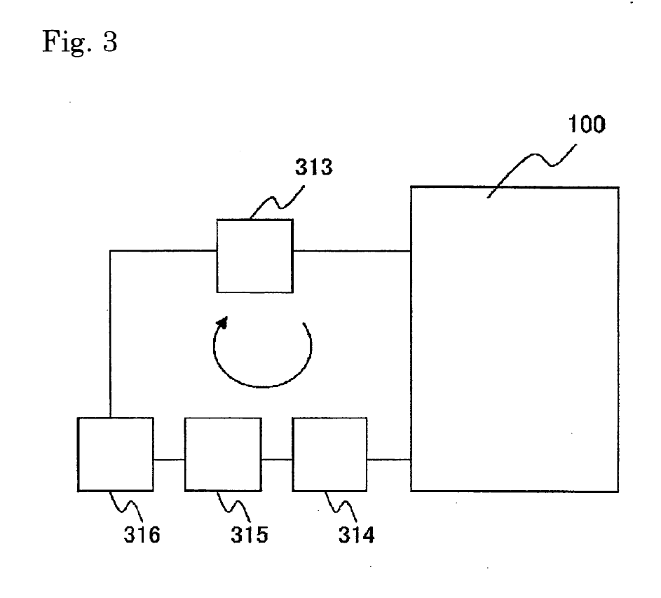

Herewith, the liquid organic fuel that did not react in the fuel electrode is recycled, and it can be used again. Such example shall be described with reference to FIG. 3.

Referring to FIG. 3, the detail of the fuel cell 100 is omitted being same as FIG. 1. According to the embodiment, a fuel supplying system comprises a fuel supplying section 313 for supplying a fuel to the fuel electrode of the fuel cell; a fuel recycling section 314 for recycling the used fuel expelled from the fuel electrode of the fuel cell; a concentration detecting section 315 for measuring concentrations of the compound and a liquid organic fuel in the used liquid fuel; and a concentration adjusting section 316 for adjusting concentrations of the compound and the liquid organic fuel in the used liquid fuel. Moreover, the fuel moves in the direction of the arrow in the drawing by the liquid transport mechanism which is not illustrated.

The fuel is supplied to the fuel electrode of the fuel cell 100 by the fuel supplying section 313. After passing through the fuel electrode, the fuel is recycled at the fuel recycling section 314. A substance generated by the electrode reaction at the fuel electrode, such as carbon dioxide, is separated at the fuel recycling section 314. Next, the recycled fuel is sent to the fuel detecting section 315 where concentrations of the compound and liquid organic fuel are measured. Based on the measured results, the concentrations of the compound and the liquid organic fuel are appropriately adjusted, and regenerated as a fuel. The fuel regenerated accordingly is sent to the fuel supplying section 313, and sent to the fuel electrode of the fuel cell 100.

The fuel cell that efficiently uses a fuel is implemented by comprising the fuel supplying system described accordingly.

### EMBODIMENTS

Hereinafter, the electrodes of the solid polymeric type fuel cell electrode and the fuel cell using them related to the present invention shall be specifically described according to the embodiments, however, it should be understood that the present invention is not necessarily limited to these.

### Embodiment 1

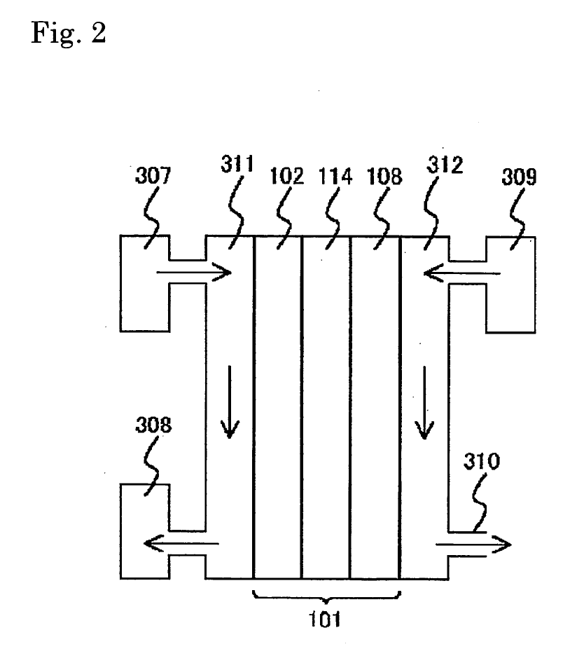

The fuel cell according to the present embodiment shall be described with reference to FIG. 2.

First of all, in the fuel electrode 102 and the oxidizing agent electrode 108, 500 g of dinitro diammine platinum nitrate solution containing 3% platinum as catalyst and 10 g of acetylene black (Denka Black®; Denki Kagaku Kogyo) are mixed and agitated. As reducing agent, 60 mL of ethanol 98% is added. The mixed solution is agitated at approximately 95° C. for 8 hours so that the catalyst substance and platinum fine powders are supporting the acetylene black powders. Then, the mixed solution is filtered, dried, and catalyst supporting carbon powders are obtained. The supporting amount of platinum is about 50% in respect to the weight of acetylene black.

Next, 200 mg of the catalyst supporting carbon powders and 3.5 mL of Naifon® solution 5% (alcohol solution; Aldrich Chemicals) is mixed and agitated. This way, Nafion® is deposited on the surfaces of carbon powders and catalyst. The dispersed solution obtained accordingly is dispersed in the ultrasonic homogenizer for 30 hours at 50° C., and a paste is formed. The paste is coated on the carbon paper (TGP-H-120; Toray) using the screen printing method at 2 mg/cm2, and dried at 120° C., and the electrode is obtained accordingly.

As the solid polymeric electrolyte film 114, Nafion 117® (thickness 150 μm) of DuPont is utilized. The electrode obtained accordingly is hot pressed at 120° C. to the solid polymeric electrolyte film 114, and the fuel electrode 102 and the oxidizing agent electrode 108 are obtained.

The solid polymeric electrolyte film 114 is sandwiched by these electrodes, and the electrode and electrolyte assembly 101 is produced by hot pressing at the condition of 150° C. temperature, 10 kgf/cm2 pressure, and 10 seconds.

For supplying a fuel to the fuel electrode 102, a fuel flow duct 311 made of tetrafluoroethylene resin is prepared on top of the fuel electrode 102. To the fuel flow duct 311, a fuel tank 307 and a liquid waste tank 308 are prepared. A pump is equipped to the fuel tank 307. As indicated by the arrows in the drawing, the configuration shows the methanol is continuously being supplied to the fuel electrode 102.

Moreover, for supplying an oxidizing agent to the oxidizing agent electrode 108, an oxidizing agent flow duct 312 made of tetrafluroethylene resin is prepared on top of the oxidizing agent electrode 108. To the oxidizing flow duct 312, an oxygen compressor 309 and an exhaust outlet 310 are prepared. As indicated by the arrows in the drawing, the configuration shows the oxygen is continuously being supplied to the oxidizing agent electrode 108.

A fuel dissolving diethylene-glycol to 10 weight % of methanol solution is poured into the fuel tank 307. Note that the concentration of diethylene-glycol of the fuel is 0.1 mol/L. This fuel is supplied to the fuel electrode 102 at 2 mL/min.

As for the oxidizing agent electrode 108, the oxygen of 1.1 atmospheric pressure at 25° C. is supplied by the oxygen compressor 309. Under these operating conditions the current and voltage characteristics of the unit cell are measured.

### Embodiment 2

A fuel dissolving glucose is poured into 10 weight % methanol solution as a fuel to be poured into the fuel tank 307 of the fuel cell having the same configuration as Embodiment 1. The glucose concentration of this fuel is 0.1 mol/L. The fuel is supplied to the fuel electrode 102 at 2 mL/min. As for the oxygen, the condition is same as Embodiment 1. Under these operating conditions, the current and voltage characteristics of the unit cell are measured.

### Embodiment 3

A fuel dissolving NaCl is poured into 10 weight % methanol solution as a fuel to be poured into the fuel tank 307 of the fuel cell having the same configuration as Embodiment 1. The NaCl concentration of this fuel is 0.1 mol/L. The fuel is supplied to the fuel electrode 102 at 2 mL/min. As for the oxygen, the condition is same as Embodiment 1.

Under these operating conditions, the current and voltage characteristics of the unit cell are measured.

### Comparative Example 1

10 weight % methanol solution is used as a fuel to be poured into the fuel tank 307 of the fuel cell having the same configuration as Embodiment 1. The fuel is supplied to the fuel electrode 102 at 2 mL/min. As for the oxygen, the condition is same as Embodiment 1.

Under these operating conditions, the current and voltage characteristics of the unit cell are measured.

Measured results of the current and voltage characteristics of fuel cells of Embodiments 1 to 3, and the comparative example 1 are shown in table 1.

TABLE 1

| | Open circuit | Short circuit | Max. power |
|---|---|---|---|
| | voltage (V) | current (mA/cm²) | (mW/cm²) |
| Embodiment 1 | 0.64 | 260 | 39 |
| Embodiment 2 | 0.65 | 280 | 49 |
| Embodiment 3 | 0.66 | 330 | 54 |
| Comparative | 0.6 | 200 | 33 |
| Example | | | |

Unit cells of Embodiments 1 to 3, compared to the unit cell of the comparative example, all of the open circuit voltage, the short circuit current, and the maximum power are found to be excellent. This is considered to have the following reasons.

As for the unit cells of Embodiments 1 to 3, diethylene glycol or glucose or NaCl is dissolved into the fuel, therefore, at the interface of fuel present in the fuel electrode 102 and the solid polymeric electrolyte film 114, an osmotic pressure in a direction from the oxidizing agent side to the fuel electrode side occurs. Because of this, the movement of water molecules in a direction from the fuel electrode to the oxidizing agent electrode is controlled, the cross-over of methanol is considered to had decreased.

Particularly, as for the unit cell of Embodiment 3, a single molecule of NaCl is dissociated to Na+ and Cl—and acts as two molecules, therefore, a larger osmotic pressure is thought to have been generated than the unit cells of Embodiments 1 and 2. Moreover, as for the unit cell of Embodiment 3, the fuel conductivity is high because the strong electrolyte is being dissolved into the fuel. This contributes to the reduction of inner resistance of the unit cell. Consequently, as a result, the performance of unit cell of Embodiment 3 is most superior.

### INDUSTRIAL APPLICABILITY

According to the present invention as described above, the cross-over of the liquid organic fuel is controlled, and the high fuel efficiency and the high output of the fuel cell is implemented.

1. A fuel for solid electrolyte type fuel cell having a solid electrolyte film, wherein the fuel includes a liquid organic fuel, and a compound excluding the sulfuric acid dissolved in the liquid organic fuel and does not permeate the solid electrolyte film.

2. The fuel for solid electrolyte type fuel cell according to claim 1, wherein the compound is non-electrolyte.

3. The fuel for solid electrolyte type fuel cell according to claim 1, wherein the compound is an organic compound different from the liquid organic fuel.

4. The fuel for solid electrolyte type fuel cell according to claim 3, wherein the organic compound is selected from at least one of sugers, alcohols and amines.

5. The fuel for solid electrolyte type fuel cell according to claim 1, wherein the compound is a strong electrolyte.

6. The fuel for solid electrolyte type fuel cell according to claim 5, wherein the strong electrolyte is chloride, nitrate, and sulfate.

7. The fuel for solid electrolyte type fuel cell according to claim 1, wherein the compound has a concentration ranging from 0.1 mmol/L to 5 mol/L.

8. The fuel for solid electrolyte type fuel cell according to claim 1, wherein the compound has a concentration ranging from 1 mmol/L to 1 mol/L.

9. The fuel for solid electrolyte type fuel cell according to claim 1, wherein the fuel has a pH value ranging from 4 to 8.

10. The fuel for solid electrolyte type fuel cell according to claim 1, wherein the compound is electrochemically inert and non-volatile.

11. A method of using the solid electrolyte type fuel cell comprising a fuel electrode, an oxidizing agent electrode, and a solid electrolyte film positioned in between the fuel electrode and the oxidizing agent electrode; wherein the fuel includes a liquid organic fuel and a compound excluding the sulfuric acid dissolved in the liquid organic fuel and does not permeate the solid electrolyte film, which is supplied to the fuel electrode.

12. The method of using the solid electrolyte type fuel cell according to claim 11, wherein the compound is non-electrolyte.

13. The method of using the solid electrolyte type fuel cell according to claim 11, wherein the compound is an organic compound different from the liquid organic fuel.

14. The method of using the solid electrolyte type fuel cell according to claim 13, wherein the organic compound is selected from at least one of sugers, alcohols, and amines.

15. The method of using the solid electrolyte type fuel cell according to claim 11, wherein the compound is a strong electrolyte.

16. The method of using the solid electrolyte type fuel cell according to claim 15, wherein the strong electrolyte is a chloride, nitrate, and sulfate.

17. The method of using the solid electrolyte type fuel cell according to claim 11, wherein the compound has a concentration ranging from 0.1 mmol/L to 5 mol/L.

18. The method of using the solid electrolyte type fuel cell according to claim 11, wherein the compound has a concentration ranging from 1 mmol/L to 1 mol/L.

19. The method of using the solid electrolyte type fuel cell according to claim 11, wherein the fuel has a pH value ranging from 4 to 8.

20. The method of using the solid electrolyte type fuel cell according to claim 11, wherein the compound is electrochemically inert and non-volatile.

21. A solid electrolyte type fuel cell, comprising: a fuel electrode; an oxidizing agent electrode; a solid electrolyte film positioned in between the fuel electrode and the oxidizing agent electrode; and a solid electrolyte type fuel cell that includes a fuel supplied to the fuel electrode, wherein the fuel includes a liquid organic fuel, and a compound excluding the sulfuric acid dissolved in the liquid organic fuel and does not permeate the solid electrolyte film.

22. The solid electrolyte type fuel cell according to claim 21, further comprising a supplying step for supplying the fuel to the fuel electrode.

23. The solid electrolyte type fuel cell according to claim 22, further comprising a recycling step for recycling a fuel expelled from the fuel electrode; a concentration adjusting step for adjusting a concentration of the compound, and the liquid organic fuel inside a recycled fuel at the recycling step; and a transporting step for transporting the fuel to the supplying step of which a concentration is adjusted by the concentration adjusting step.

24. The solid electrolyte type fuel cell according to claim 21, wherein the compound is a non-electrolyte.

25. The solid electrolyte type fuel cell according to claim 21, wherein the compound is an organic compound different from the liquid organic fuel.

26. The solid electrolyte type fuel cell according to claim 25, wherein the organic compound is selected from at least one of sugers, alcohols, and amines.

27. The solid electrolyte type fuel cell according to claim 21, wherein the compound is a strong electrolyte.

28. The solid electrolyte type fuel cell according to claim 27, wherein the strong electrolyte is chloride, nitrate, and sulfate.

29. The solid electrolyte type fuel cell according to claim 21, wherein the compound has a concentration ranging from 0.1 mmol/L to 5 mol/L.

30. The solid electrolyte type fuel cell according to claim 29, wherein the compound has a concentration ranging from 1 mmol/L to 1 mol/L.

31. The solid electrolyte type fuel cell according to claim 21, wherein the fuel has a pH value ranging from 4 to 8.

32. The solid electrolyte type fuel cell according to claim 21, wherein the compound is electrochemically inert and non-volatile.
